(19) United States
(12) Patent Application Publication
(10) Pub. No.: US 2026/0088483 A1
(43) Pub. Date: Mar. 26, 2026

(54) DIGITAL ISOLATOR CIRCUIT WITH SERIALLY CONNECTED ISOLATION CAPACITORS

(71) Applicant: AMAZING MICROELECTRONIC CORP., New Taipei City (TW)

(72) Inventor: Guan-Shun LI, Zhubei City (TW)

(73) Assignee: AMAZING MICROELECTRONIC CORP., New Taipei City (TW)

(21) Appl. No.: 19/331,469

(22) Filed: Sep. 17, 2025

(30) Foreign Application Priority Data
Sep. 25, 2024 (CN) 202411336475.8

(51) Int. Cl. H01P 1/36

(52) U.S. Cl. CPC H01P 1/36

(57) ABSTRACT

A digital isolator circuit with serially connected isolation capacitors is provided, comprising a first integrated circuit region and a second integrated circuit region. A first transceiver and a plurality of serially connected high-voltage isolation capacitors are configured in the first integrated circuit region. A second transceiver and a plurality of serially connected high-voltage isolation capacitors are configured in the second integrated circuit region. A metal wire bonding is connected between the high-voltage isolation capacitors in the first and second integrated circuit region, but not in contact with the isolation capacitors connected to the first and second transceivers. Since the proposed digital isolator circuit is characterized by having serially connected isolation capacitors, damages to the dielectric layer caused by the metal wire bonding can be suppressed, enhancing the entire yield, ensuring withstanding voltages and thus having higher tolerance to the wiring encapsulation environment.

### BACKGROUND OF THE INVENTION

This application claims priority for the CN patent application No. 202411336475.8 filed on 25 Sep. 2024, the content of which is incorporated by reference in its entirely.

### FIELD OF THE INVENTION

The present invention is related to a digital isolator diagram. And more particularly, the present invention is related to a digital isolator circuit having serially connected isolation capacitors, such that the dielectric layer can be effectively avoided from being damaged by the hard force due to metal wire bonding, thereby improving an overall yield and voltage endurance of the isolator device. In addition, an improved tolerance for the device's wire bonding package environments is accomplished.

### DESCRIPTION OF THE PRIOR ART

As we know, many electronic systems have certain needs to isolate electrical signals in one portion of the system from electrical signals in another portion of the system. In many control systems, for example, both high voltage and low voltage signals may be generated and monitored, and isolation between these signals is required for proper operation of the system. Therefore, isolation circuits are known as the interface circuits that provide galvanic isolation between two communicating blocks, for example, a transmitter circuit (TX) and a receiver circuit (RX). Such isolation circuits are required to eliminate avoidable ground loops, and also to protect high voltage sensitive circuits. These circuits ensure electric insulation and signal isolation between the circuits, ensuring reliable data transmission between the two circuits, isolating the signal from fast transient common mode noise.

In general, a variety of different devices and techniques have been utilized to communicate signals from one portion of a system to another portion of the system while maintaining isolation between the portions. Devices that provide this communication and isolation are generally referred to as digital isolators. In operation, a digital isolator receives an input electrical signal from a first portion of a system and converts this signal into a corresponding signal that is then communicated across an isolation barrier. The signal communicated across the isolation barrier is received and converted into an isolated output electrical signal that is then applied to a second portion of the system, with the received electrical signal corresponding to the input electrical signal from the first portion of the system.

However, it has been known that for the current existing digital isolators, a metal wire bonding configuration is mostly adopted between the above mentioned first portion and the second portion of the system. And, a hard force is usually accordingly generated due to the metal wire bonding process, and damages the high-voltage capacitors disposed in the digital isolator. As a result, the voltage endurance of the isolator device will be affected and become degraded. It should be acknowledged that this is a main issue which needs to be addressed and overcome. On account of the above mentioned technical backgrounds, these have been known as several shortcomings and defects of the existing technology that need to be improved in the technical fields. And since the existing digital isolator architecture still has such deficiencies and defects as mentioned above, it is believed that the conventional digital isolator architectures cannot be effectively and widely used in the industries until these days.

Therefore, on account of the above, to overcome the above-mentioned problems, it should be obvious that there is indeed an urgent need for the professionals in the field for proposing a new digital isolator circuit, which is to be developed that can effectively solve the above-mentioned problems occurring in the prior design. And by using such technical contents of the present invention, not only a better voltage endurance ability can be reached. An improved tolerance for wire bonding package environment can be achieved as well. As a result, by providing the present invention, it is believed that those long-standing shortcomings in the prior arts can be successfully solved. Hereinafter, the detailed specific implementations will be fully described in the following paragraphs.

### SUMMARY OF THE INVENTION

In order to overcome the above-mentioned disadvantages, one major objective in accordance with the present invention is to provide a novel and inventive digital isolator diagram, which is characterized by having a plurality of serially connected isolation capacitors. By employing multiple high-voltage isolation capacitors which are connected in series in the isolation barrier, metal wire bonding is only connected between two adjacent isolation capacitors without contacting with the isolation capacitors which are connected with the transceivers. As such, the damages to the high-voltage isolation capacitors due to metal wire bonding can be effectively suppressed, ensuring the digital isolator circuit a better reliability and voltage withstanding abilities.

In addition, another objective of the present invention is to provide a digital isolator circuit with serially connected isolation capacitors. Since a plurality of high-voltage isolation capacitors are configured in the proposed digital isolator circuit, it is effective to protect the isolation capacitors from being damaged by the metal wire bonding. And therefore, an overall yield of the device can be greatly improved, and a higher tolerance for the package encapsulation environment can be accomplished as well.

And still in another aspect, one another objective of the disclosed digital isolator circuit with serially connected isolation capacitors is that, since a higher tolerance for the package encapsulation environment can be reached by employing the disclosed digital isolator circuit, it is believed that a less expensive material, such as copper and silver can be used for metal wire bonding instead of the expensive gold material. As such, the cost for metal wire bonding process can be significantly reduced by using the present invention, providing better advantages and market competitiveness in the technical fields. As for the technical solution disclosed in the following embodiments of this application, it has been effectively verified and having a plurality of merits including high industrial competitiveness, and therefore can be widely used in any related industrial technologies.

In order to achieve the numerous above mentioned objectives, the technical solutions of the present invention are aimed to provide a digital isolator circuit with serially connected isolation capacitors. The proposed digital isolator circuit with serially connected isolation capacitors includes a first integrated circuit region and a second integrated circuit region, wherein the first integrated circuit region includes a first transceiver and a first isolation barrier, the first isolation barrier includes a plurality of first isolation capacitors, and the plurality of first isolation capacitors are electrically connected in series.

The second integrated circuit region comprises a second transceiver and a second isolation barrier, wherein the second isolation barrier includes a plurality of second isolation capacitors, and the plurality of second isolation capacitors are electrically connected in series. According to the embodiment of the present invention, a first metal wire bonding is electrically connected between the plurality of first isolation capacitors and the plurality of second isolation capacitors, and the first metal wire bonding is only configured and disposed between one of the plurality of first isolation capacitors and one of the plurality of second isolation capacitors without contacting with another one of the plurality of first isolation capacitors which is connected with the first transceiver and without contacting with another one of the plurality of second isolation capacitors which is connected with the second transceiver.

A second embodiment is also provided according to the present invention. According to the second embodiment of the present invention, the above mentioned first isolation barrier may further comprise a plurality of third isolation capacitors, and the plurality of third isolation capacitors are electrically connected in series. The plurality of third isolation capacitors and the plurality of first isolation capacitors are electrically connected in parallel. And, the plurality of first isolation capacitors are electrically connected with the first transceiver so as to provide a first data transmission channel, and the plurality of third isolation capacitors are electrically connected with the first transceiver so as to provide a second data transmission channel.

By employing the similar manners, according to the second embodiment of the present invention, the above mentioned second isolation barrier may further comprise a plurality of fourth isolation capacitors, and the plurality of fourth isolation capacitors are electrically connected in series. The plurality of fourth isolation capacitors and the plurality of second isolation capacitors are electrically connected in parallel. And, the plurality of second isolation capacitors are electrically connected with the plurality of first isolation capacitors and the second transceiver so as to provide the first data transmission channel, and the plurality of fourth isolation capacitors are electrically connected with the plurality of third isolation capacitors and the second transceiver so as to provide the second data transmission channel.

In the second embodiment of the present invention, a first metal wire bonding is electrically connected between the plurality of first isolation capacitors and the plurality of second isolation capacitors, a second metal wire bonding is electrically connected between the plurality of third isolation capacitors and the plurality of fourth isolation capacitors. The first metal wire bonding is only configured and disposed between one of the plurality of first isolation capacitors and one of the plurality of second isolation capacitors without contacting with another one of the plurality of first isolation capacitors which is connected with the first transceiver and without contacting with another one of the plurality of second isolation capacitors which is connected with the second transceiver.

In addition, the second metal wire bonding is only configured and disposed between one of the plurality of third isolation capacitors and one of the plurality of fourth isolation capacitors without contacting with another one of the plurality of third isolation capacitors which is connected with the first transceiver and without contacting with another one of the plurality of fourth isolation capacitors which is connected with the second transceiver.

According to the first and second embodiments of the present invention, each of the plurality of first isolation capacitors, each of the plurality of second isolation capacitors, each of the plurality of third isolation capacitors and each of the plurality of fourth isolation capacitors includes an upper metal plate, a lower metal plate, and a dielectric layer disposed between the upper metal plate and the lower metal plate, and in the two of the plurality of first isolation capacitors which are connected in series, the lower metal plate of one of the plurality of first isolation capacitors and the upper metal plate of another one of the plurality of first isolation capacitors are electrically connected through a first inner metal via. In the two of the plurality of second isolation capacitors which are connected in series, the lower metal plate of one of the plurality of second isolation capacitors and the upper metal plate of another one of the plurality of second isolation capacitors are electrically connected through a second inner metal via. In the two of the plurality of third isolation capacitors which are connected in series, the lower metal plate of one of the plurality of third isolation capacitors and the upper metal plate of another one of the plurality of third isolation capacitors are electrically connected through a third inner metal via, and in the two of the plurality of fourth isolation capacitors which are connected in series, the lower metal plate of one of the plurality of fourth isolation capacitors and the upper metal plate of another one of the plurality of fourth isolation capacitors are electrically connected through a fourth inner metal via.

Furthermore, one of the plurality of first isolation capacitors and one of the plurality of third isolation capacitors which are electrically connected in parallel in the first isolation barrier may be alternatively to commonly use a same metal electrode plate. Similarly, one of the plurality of second isolation capacitors and one of the plurality of fourth isolation capacitors which are electrically connected in parallel in the second isolation barrier may be also alternatively to commonly use a same metal electrode plate.

In addition, according to the proposed digital isolator circuit in the present invention, a bi-directional data transmission can be implemented. For instance, in one embodiment, when the first transceiver in the first integrated circuit region is adapted to receive a data input signal, in response to the data input signal and operable to generate an isolated output signal, the second transceiver in the second integrated circuit region is adapted to receive the isolated output signal so as to generate a data output signal.

And yet, according to another embodiment of the present invention, when the second transceiver in the second integrated circuit region is adapted to receive a data input signal, in response to the data input signal and operable to generate an isolated output signal, the first transceiver in the first integrated circuit region is adapted to receive the isolated output signal so as to generate a data output signal.

As a result, to sum up, it is obvious that the present invention provides a well-designed architecture for digital isolator circuit diagram which is characterized by having multiple serially connected high-voltage isolation capacitors therein. By employing such technical solutions that serially connect a plurality of high-voltage isolation capacitors in the digital isolator circuit, it effectively suppresses damage to the dielectric layer of the high-voltage isolation capacitors caused by the conventional metal wire bonding. Since the voltage withstand capability of digital isolator circuit components mainly depends on the dielectric layer of the high-voltage isolation capacitors, when the dielectric layer is protected from being damaged, a better and improved voltage withstand capability can be achieved. Furthermore, it has also been proven that the present invention is able to successfully minimize the hard force interference due to the metal wire bonding process, thereby ensuring voltage withstand capability, achieving overall higher yield, and providing greater environmental tolerance to wire bonding encapsulation environments. And moreover, by employing the digital isolator circuit disclosed in this invention, data signal transmission can be well maintained and will not be affected. As a result, it is believed that the disclosed digital isolator circuit with serially connected isolation capacitors as proposed in the present invention is beneficial to provide excellent system robustness and accurate data transmission. While compared with the prior arts, it is believed that the present invention has a plurality of advantages including well system-level control stability and precise control of the isolation circuit. And therefore, as compared to the prior arts, it is believed that the present invention is characterized by a merit of novelty and inventive benefits.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings:

FIG. 1 shows a structural diagram schematically illustrating the digital isolator circuit with serially connected isolation capacitors in accordance with a first embodiment of the present invention.

FIG. 2 shows a structural diagram schematically illustrating a detailed configuration of the disclosed first isolation barrier according to the first embodiment of the present invention.

FIG. 3 shows a modified embodiment from FIG. 2, wherein a plurality of serially connected first isolation capacitors C11, C12, C13 . . . . CIN are further configured.

FIG. 4 shows a structural diagram schematically illustrating a detailed configuration of the disclosed second isolation barrier according to the first embodiment of the present invention.

FIG. 5 shows a modified embodiment from FIG. 4, wherein a plurality of serially connected second isolation capacitors C21, C22, C23 . . . . C2N are further configured.

FIG. 6 shows a structural diagram schematically illustrating signal coupling from the first transceiver to the second transceiver in view of the first embodiment in FIG. 1 of the present invention.

FIG. 7 shows a structural diagram schematically illustrating signal coupling from the second transceiver to the first transceiver in view of the first embodiment in FIG. 1 of the present invention.

FIG. 8 shows a structural diagram schematically illustrating the digital isolator circuit with serially connected isolation capacitors in accordance with a second embodiment of the present invention, wherein a first data transmission channel and a second data transmission channel are provided.

FIG. 9 shows a structural diagram schematically illustrating a detailed configuration of the disclosed first isolation barrier according to the second embodiment of the present invention, comprising a plurality of serially connected first isolation capacitors and a plurality of serially connected third isolation capacitors.

FIG. 10 shows a structural diagram schematically illustrating a detailed configuration of the disclosed second isolation barrier according to the second embodiment of the present invention, comprising a plurality of serially connected second isolation capacitors and a plurality of serially connected fourth isolation capacitors.

FIG. 11 shows a structural diagram schematically illustrating signal coupling from the first transceiver to the second transceiver in view of the second embodiment in FIG. 8 of the present invention.

FIG. 12 shows a structural diagram schematically illustrating signal coupling from the second transceiver to the first transceiver in view of the second embodiment in FIG. 8 of the present invention.

### DESCRIPTION OF THE PREFERRED EMBODIMENTS

Reference will now be made in detail to embodiments illustrated in the accompanying drawings. Wherever possible, the same reference numbers will be used in the drawings and the description to refer to the same or like parts. In the drawings, the shape and thickness may be exaggerated for clarity and convenience. This description will be directed in particular to elements forming part of, or cooperating more directly with, methods and apparatus in accordance with the present disclosure. It is to be understood that elements not specifically shown or described may take various forms well known to those skilled in the art. Many alternatives and modifications will be apparent to those skilled in the art, once informed by the present disclosure.

Unless otherwise specified, some conditional sentences or words, such as “can”, “could”, “might”, or “may”, usually attempt to express that the embodiment in the invention has, but it can also be interpreted as a feature, element, or step that may not be needed. In other embodiments, these features, elements, or steps may not be required.

Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

Certain terms are used throughout the description and the claims to refer to particular components. One skilled in the art appreciates that a component may be referred to as different names. This disclosure does not intend to distinguish between components that differ in name but not in function. In the description and in the claims, the term “comprise” is used in an open-ended fashion, and thus should be interpreted to mean “include, but not limited to.” The phrases “be coupled to,” “couples to,” and “coupling to” are intended to compass any indirect or direct connection. Accordingly, if this disclosure mentioned that a first device is coupled with a second device, it means that the first device may be directly or indirectly connected to the second device through electrical connections, wireless communications, optical communications, or other signal connections with/without other intermediate devices or connection means.

The invention is particularly described with the following examples which are only for instance. Those skilled in the art will readily observe that numerous modifications and alterations of the device and method may be made while retaining the teachings of the invention. Accordingly, the following disclosure should be construed as limited only by the metes and bounds of the appended claims. In the whole patent application and the claims, except for clearly described content, the meaning of the article “a” and “the” includes the meaning of “one or at least one” of the element or component. Moreover, in the whole patent application and the claims, except that the plurality can be excluded obviously according to the context, the singular articles also contain the description for the plurality of elements or components. In the entire specification and claims, unless the contents clearly specify the meaning of some terms, the meaning of the article “wherein” includes the meaning of the articles “wherein” and “whereon”. The meanings of every term used in the present claims and specification refer to a usual meaning known to one skilled in the art unless the meaning is additionally annotated. Some terms used to describe the invention will be discussed to guide practitioners about the invention. Every example in the present specification cannot limit the claimed scope of the invention.

The terms “substantially,” “around,” “about” and “approximately” can refer to within 20% of a given value or range, and preferably within 10%. Besides, the quantities provided herein can be approximate ones and can be described with the aforementioned terms if are without being specified. When a quantity, density, or other parameters includes a specified range, preferable range or listed ideal values, their values can be viewed as any number within the given range.

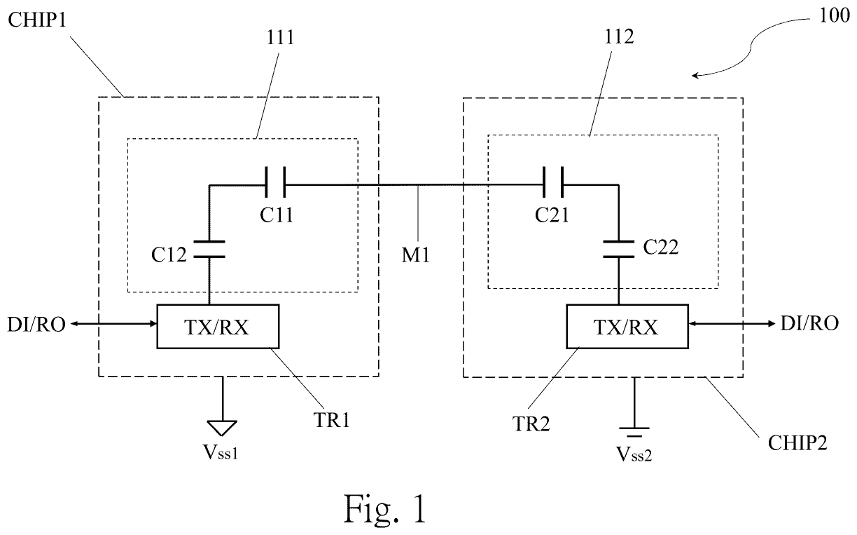

In the following descriptions, a digital isolator circuit with serially connected isolation capacitors is to be provided first. Please refer to FIG. 1, which shows a structural diagram schematically illustrating the digital isolator circuit with serially connected isolation capacitors in accordance with a first embodiment of the present invention. As illustrated in the disclosed embodiment in FIG. 1, the proposed digital isolator circuit with serially connected isolation capacitors 100 comprises a first integrated circuit (IC) region CHIP1 and a second integrated circuit (IC) region CHIP2. The first integrated circuit (IC) region CHIP1 is electrically connected to a first ground voltage level Vₛₛ₁ and the second integrated circuit (IC) region CHIP2 is electrically connected to a second ground voltage level Vₛₛ₂.

In detailed configurations of the present invention, the first integrated circuit region CHIP1 comprises a first transceiver (TX/RX) TR1 and a first isolation barrier 111. The first isolation barrier 111 includes a plurality of first isolation capacitors C11, C12, the first isolation capacitors C11, C12 are high-voltage (HV) isolation capacitors, and the plurality of first isolation capacitors C11, C12 are electrically connected in series.

In addition, the second integrated circuit region CHIP2 comprises a second transceiver (TX/RX) TR2 and a second isolation barrier 112. The second isolation barrier 112 includes a plurality of second isolation capacitors C21, C22, the second isolation capacitors C21, C22 are high-voltage (HV) isolation capacitors, and the plurality of second isolation capacitors C21, C22 are electrically connected in series. By such electrical configurations, the disclosed first isolation barrier 111 and second isolation barrier 112 are electrically connected between the first transceiver TR1 in the first integrated circuit region CHIP1 and the second transceiver TR2 in the second integrated circuit region CHIP2.

According to one embodiment of the present invention, the disclosed first isolation barrier 111 and second isolation barrier 112 used in the present invention, for example can be composed of at least one isolation capacitor or the like. The present invention is not limited thereby the type or number of isolation capacitors constituting the isolation barriers.

Specifically, according to the first embodiment of the present invention, a first metal wire bonding M1 is electrically connected between the first isolation capacitor C11 in the first integrated circuit region CHIP1 and the second isolation capacitor C21 in the second integrated circuit region CHIP2. As illustrated in FIG. 1, the first metal wire bonding M1 is only configured and disposed between the first isolation capacitor C11 and the second isolation capacitor C21 without contacting with another first isolation capacitor C12 which is connected with the first transceiver TR1 and without contacting with another second isolation capacitor C22 which is connected with the second transceiver TR2.

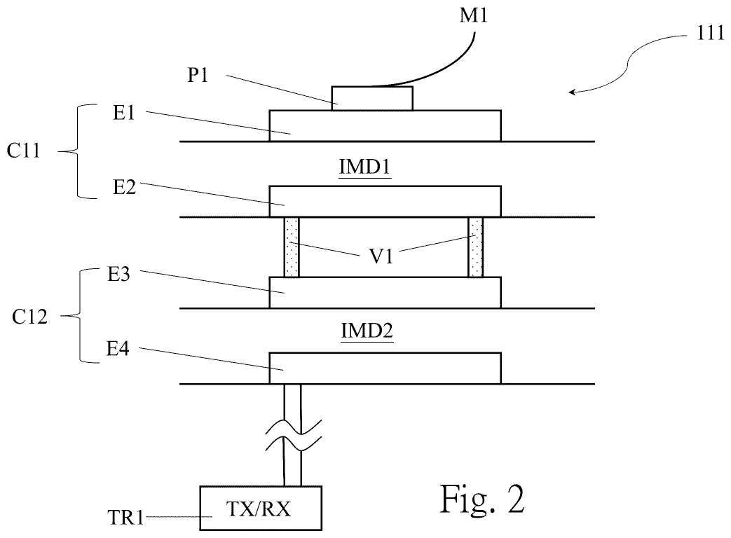

Please refer to FIG. 2, which shows a structural diagram schematically illustrating a detailed configuration of the above mentioned first isolation barrier 111 according to the first embodiment of the present invention. As can be seen in FIG. 2, the proposed first isolation barrier 111 in the first embodiment comprises serially connected first isolation capacitors C11 and C12, wherein the first isolation capacitor C11 includes an upper metal plate E1, a lower metal plate E2, and a dielectric layer IMD1 disposed between the upper metal plate E1 and the lower metal plate E2. An open pad P1 is disposed and configured on the upper metal plate E1, thereby providing the first metal wire bonding M1 is connected thereto.

Similarly, the first isolation capacitor C12 includes an upper metal plate E3, a lower metal plate E4, and a dielectric layer IMD2 disposed between the upper metal plate E3 and the lower metal plate E4. Furthermore, in the two first isolation capacitors C11, C12 which are connected in series, the lower metal plate E2 of the first isolation capacitor C11 and the upper metal plate E3 of the first isolation capacitor C12 are electrically connected through a first inner metal via V1. By such configurations, since the proposed first isolation barrier 111 is composed of multiple serially connected isolation capacitors, having both upper plate and lower plate made of metal material, it is known that the metal material is relatively soft, so it can be effective to reduce the damage to the dielectric layer generated by the hard force due to the first metal wire bonding M1. In other words, even if the hard force (stress, or stiffness) generated by the first metal wire bonding M1 affects the dielectric layer, the affected area is merely limited to the dielectric layer IMD1 of the first isolation capacitor C11 and will not affect its underlying dielectric layer IMD2.

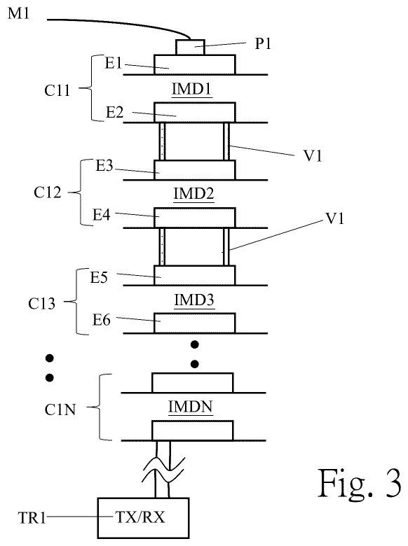

And moreover, in another aspect, according to one another alternative embodiment of the present invention, then the proposed first isolation barrier 111 may further comprise a plurality of more first isolation capacitors, which are connected in series. Please refer to FIG. 3, which shows a modified embodiment from FIG. 2. As can be seen, the disclosed first isolation barrier 111 in FIG. 3, may comprise a plurality of serially connected first isolation capacitors C11, C12, C13 . . . . CIN. As a result, in such a modified embodiment, it should be apparent that even if the hard force (stress, or stiffness) generated by the first metal wire bonding M1 affects the dielectric layer, the affected area is merely limited to the top dielectric layer IMD1 of the first isolation capacitor C11 and will not affect its underlying other dielectric layers IMD2, IMD3 . . . . IMDN of the first isolation capacitors C12, C13 . . . . CIN. Therefore, according to the above disclosed technical solution in the present invention, it is believed that when the proposed digital isolator circuit of the present invention is applied, it is effective to ensure that the dielectric layer of the device is mostly not damaged, thereby still having well voltage withstanding abilities.

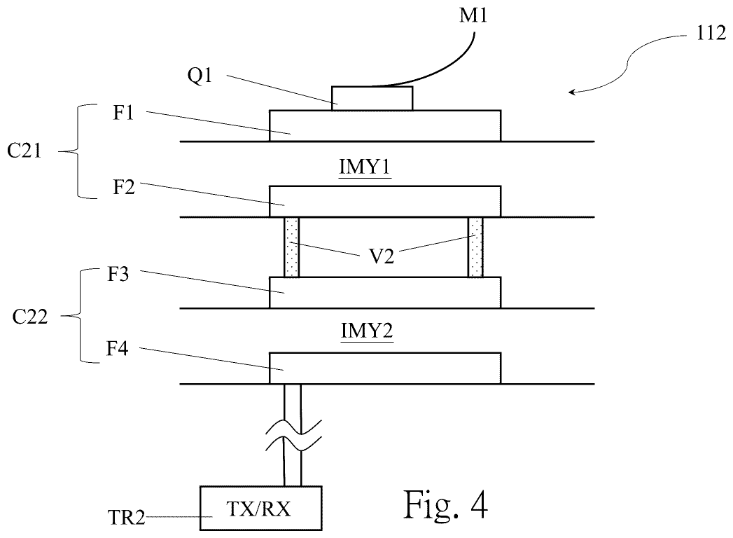

By adopting the similar design manners, please refer to FIG. 4, which shows a structural diagram schematically illustrating a detailed configuration of the above mentioned second isolation barrier 112 according to the first embodiment of the present invention. As can be seen in FIG. 4, the proposed second isolation barrier 112 in the first embodiment comprises serially connected second isolation capacitors C21 and C22, wherein the second isolation capacitor C21 includes an upper metal plate F1, a lower metal plate F2, and a dielectric layer IMY1 disposed between the upper metal plate F1 and the lower metal plate F2. An open pad Q1 is disposed and configured on the upper metal plate F1, thereby providing the first metal wire bonding M1 is connected thereto.

Similarly, the second isolation capacitor C22 includes an upper metal plate F3, a lower metal plate F4, and a dielectric layer IMY2 disposed between the upper metal plate F3 and the lower metal plate F4. Furthermore, in the two second isolation capacitors C21, C22 which are connected in series, the lower metal plate F2 of the second isolation capacitor C21 and the upper metal plate F3 of the second isolation capacitor C22 are electrically connected through a second inner metal via V2. By such configurations, since the proposed second isolation barrier 112 is composed of multiple serially connected isolation capacitors, having both upper plate and lower plate made of metal material, it is known that the metal material is relatively soft, so it can be effective to reduce the damage to the dielectric layer generated by the hard force due to the first metal wire bonding M1. In other words, even if the hard force (stress, or stiffness) generated by the first metal wire bonding M1 affects the dielectric layer, the affected area is merely limited to the dielectric layer IMY1 of the second isolation capacitor C21 and will not affect its underlying dielectric layer IMY2.

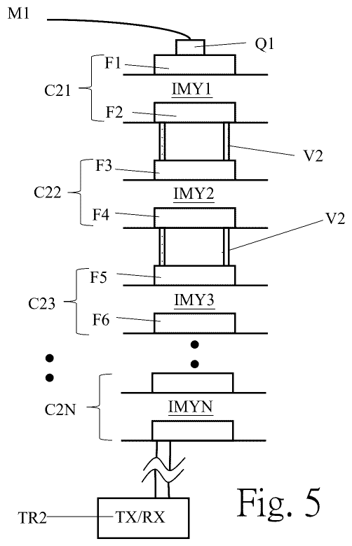

And moreover, in another aspect, according to one yet another alternative embodiment of the present invention, then the proposed second isolation barrier 112 may further comprise a plurality of more second isolation capacitors, which are connected in series. Please refer to FIG. 5, which shows a modified embodiment from FIG. 4. As can be seen, the disclosed second isolation barrier 112 in FIG. 5, may comprise a plurality of serially connected second isolation capacitors C21, C22, C23 . . . . C2N. As a result, in such a modified embodiment, it should be apparent that even if the hard force (stress, or stiffness) generated by the first metal wire bonding M1 affects the dielectric layer, the affected area is merely limited to the top dielectric layer IMY1 of the second isolation capacitor C21 and will not affect its underlying other dielectric layers IMY2, IMY3 . . . . IMYN of the second isolation capacitors C22, C23 . . . . C2N. As a result, according to the above disclosed technical solution in the present invention, it is believed that when the proposed digital isolator circuit of the present invention is applied, it is also effective to ensure that the dielectric layer of the device is mostly not damaged, thereby still having well voltage withstanding abilities.

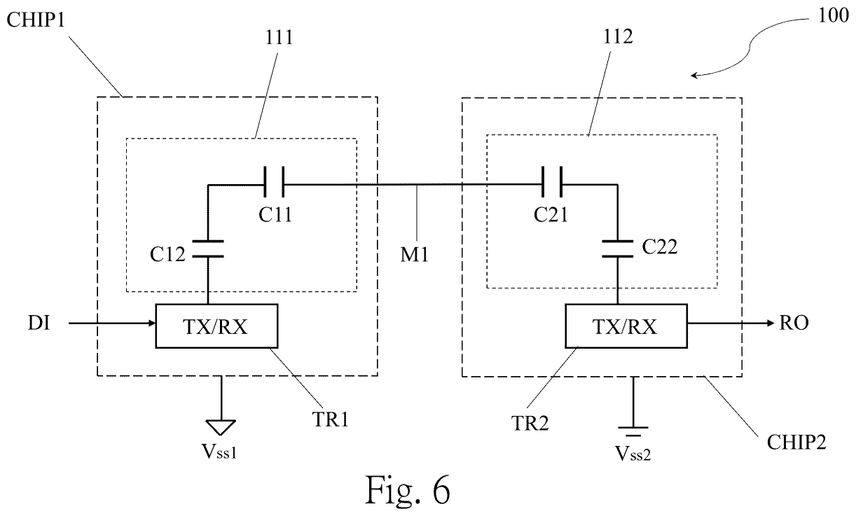

Besides, according to the disclosed digital isolator circuit with serially connected isolation capacitors of the present invention, a bi-directional data transmission can be provided. In one feasible embodiment of the present invention, for example, in FIG. 6, when the first transceiver TR1 in the first integrated circuit region CHIP1 is adapted to receive a data input signal DI and in response to the data input signal DI, the first transceiver TR1 is operable to generate an isolated output signal through the first isolation barrier 111. And afterwards, by employing the signal coupling due to the second isolation barrier 112, the second transceiver TR2 in the second integrated circuit region CHIP2 can be adapted to receive the isolated output signal so as to generate a data output signal RO.

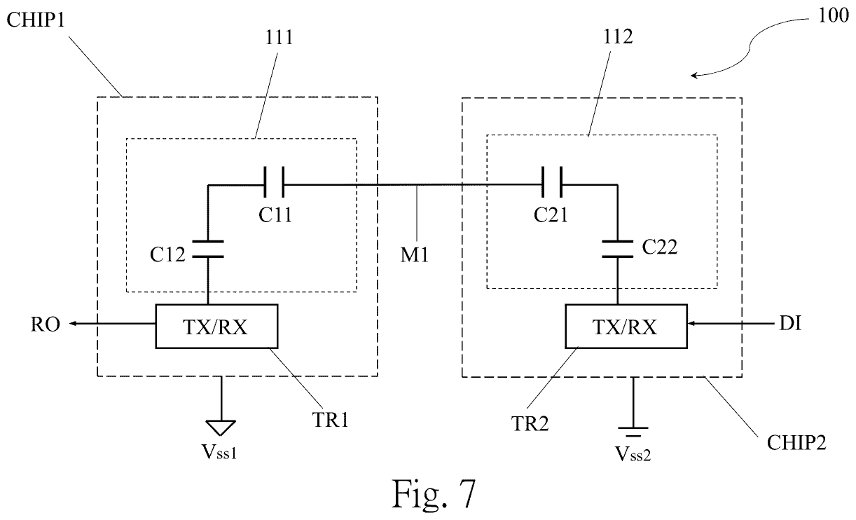

More alternatively, according to another feasible embodiment of the present invention, for example, please refer to FIG. 7. As can be seen in FIG. 7, when the second transceiver TR2 in the second integrated circuit region CHIP2 is adapted to receive a data input signal DI and in response to the data input signal DI, the second transceiver TR2 is operable to generate an isolated output signal through the second isolation barrier 112. And afterwards, by employing the signal coupling due to the first isolation barrier 111, the first transceiver TR1 in the first integrated circuit region CHIP1 can be adapted to receive the isolated output signal so as to generate a data output signal RO.

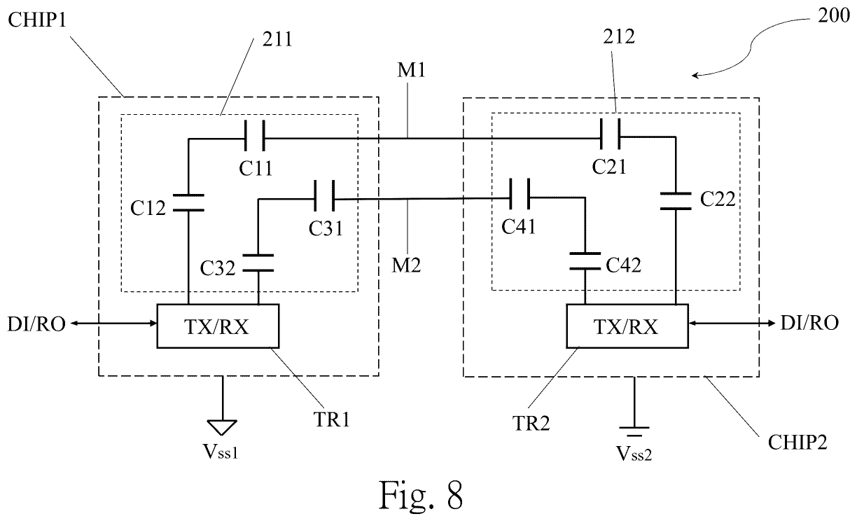

And furthermore, in another aspect, FIG. 8 additionally shows a structural diagram schematically illustrating the digital isolator circuit with serially connected isolation capacitors in accordance with a second embodiment of the present invention. As illustrated in the disclosed second embodiment in FIG. 8, in addition to the previously disclosed first transceiver TR1, second transceiver TR2, serially connected first isolation capacitors C11, C12, serially connected second isolation capacitors C21, C22, the proposed digital isolator circuit with serially connected isolation capacitors 200 in the second embodiment further comprises a plurality of third isolation capacitors C31, C32 disposed in the first isolation barrier 211. The plurality of third isolation capacitors C31, C32 are electrically connected in series, and the plurality of third isolation capacitors C31, C32 and the plurality of first isolation capacitors C11, C12 are electrically connected in parallel. According to the second embodiment of the present invention, the plurality of first isolation capacitors C11, C12 are electrically connected with the first transceiver TR1 so as to provide a first data transmission channel. And the plurality of third isolation capacitors C31, C32 are electrically connected with the first transceiver TR1 so as to provide a second data transmission channel.

In addition to the plurality of second isolation capacitors C21, C22 as previously disclosed in the first embodiment, the second isolation barrier 212 in the second embodiment further comprises a plurality of fourth isolation capacitors C41, C42. And the plurality of fourth isolation capacitors C41, C42 are electrically connected in series. The plurality of fourth isolation capacitors C41, C42 and the plurality of second isolation capacitors C21, C22 are electrically connected in parallel. According to the second embodiment, the serially connected second isolation capacitors C21, C22 are electrically connected with the plurality of first isolation capacitors C11, C12 and the second transceiver TR2 so as to provide the first data transmission channel, and the serially connected fourth isolation capacitors C41, C42 are electrically connected with the plurality of third isolation capacitors C31, C32 and the second transceiver TR2, so as to provide the second data transmission channel.

In detailed configurations, as disclosed in the second embodiment of the present invention, a first metal wire bonding M1 is electrically connected between the first isolation capacitor C11 in the first integrated circuit region CHIP1 and the second isolation capacitor C21 in the second integrated circuit region CHIP2. A second metal wire bonding M2 is electrically connected between the third isolation capacitor C31 and the fourth isolation capacitor C41. As such, according to the technical contents of the invention, the above mentioned first metal wire bonding M1 is only configured and disposed between the first isolation capacitor C11 and the second isolation capacitor C21. And the first metal wire bonding M1 does not make contact with another first isolation capacitor C12 which is connected with the first transceiver TR1. And the first metal wire bonding M1 also does not make contact with another second isolation capacitor C22 which is connected with the second transceiver TR2.

By adopting the similar configuration manners, the disclosed second metal wire bonding M2 is only configured and disposed between the third isolation capacitor C31 and the fourth isolation capacitor C41. And the second metal wire bonding M2 does not make contact with another third isolation capacitor C32 which is connected with the first transceiver TR1. And the second metal wire bonding M2 also does not make contact with another fourth isolation capacitor C42 which is connected with the second transceiver TR2. As a result, it is believed that when the proposed digital isolator circuit of the present invention is applied and metal wire bonding process is carried out, even if the hard force (stress, or stiffness) generated by the second metal wire bonding M2 affects the dielectric layer, the affected area is merely limited to the dielectric layer of the third isolation capacitor C31 and the dielectric layer of the fourth isolation capacitor C41 which are connected with the second metal wire bonding M2 and will not the dielectric layers of other remaining isolation capacitors, so as to protect those dielectric layers from being damaged and maintaining the device a superior voltage withstanding ability.

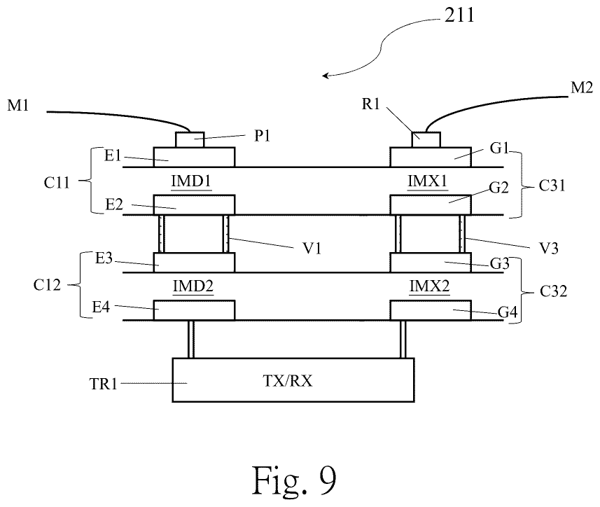

Furthermore, please proceed to refer to FIG. 9, which shows a structural diagram schematically illustrating a detailed configuration of the above mentioned first isolation barrier 211 according to the second embodiment of the present invention. As can be seen in FIG. 9, the proposed first isolation barrier 211 in the second embodiment comprises serially connected first isolation capacitors C11, C12 and serially connected third isolation capacitors C31, C32. Specifically, the first isolation capacitor C11 includes an upper metal plate E1, a lower metal plate E2, and a dielectric layer IMD1 disposed between the upper metal plate E1 and the lower metal plate E2. An open pad P1 is disposed and configured on the upper metal plate E1, thereby providing the first metal wire bonding M1 is connected thereto. The third isolation capacitor C31 includes an upper metal plate G1, a lower metal plate G2, and a dielectric layer IMX1 disposed between the upper metal plate G1 and the lower metal plate G2. An open pad R1 is disposed and configured on the upper metal plate G1, thereby providing the second metal wire bonding M2 is connected thereto.

Similarly, the first isolation capacitor C12 includes an upper metal plate E3, a lower metal plate E4, and a dielectric layer IMD2 disposed between the upper metal plate E3 and the lower metal plate E4. Furthermore, the third isolation capacitor C32 includes an upper metal plate G3, a lower metal plate G4, and a dielectric layer IMX2 disposed between the upper metal plate G3 and the lower metal plate G4. In the two first isolation capacitors C11, C12 which are connected in series, the lower metal plate E2 of the first isolation capacitor C11 and the upper metal plate E3 of the first isolation capacitor C12 are electrically connected through a first inner metal via V1. In the two third isolation capacitors C31, C32 which are connected in series, the lower metal plate G2 of the third isolation capacitor C31 and the upper metal plate G3 of the third isolation capacitor C32 are electrically connected through a third inner metal via V3.

According to the embodiment of the present invention, the first isolation capacitor C11 and the third isolation capacitor C31 which are electrically connected in parallel in the first isolation barrier 211 commonly uses a same metal electrode plate. The first isolation capacitor C12 and the third isolation capacitor C32 which are electrically connected in parallel are also operable to commonly use a same metal electrode plate.

As a result, by adopting such circuit configurations, since the proposed first isolation barrier 211 is composed of multiple serially connected first isolation capacitors C11, C12 and multiple serially connected third isolation capacitors C31, C32, having both upper plate and lower plate made of metal material, it is known that the metal material is relatively soft, so it can be effective to reduce the damage to the dielectric layer generated by the hard force due to the first metal wire bonding M1 as well as the second metal wire bonding M2. In other words, even if the hard force (stress, or stiffness) generated by the first metal wire bonding M1 and the second metal wire bonding M2 affects the dielectric layer, the affected area is merely limited to the dielectric layer IMD1 of the first isolation capacitor C11 and the dielectric layer IMX1 of the third isolation capacitor C31 and yet, will not affect its underlying dielectric layers IMD2 and IMX2.

And moreover, in another aspect, according to one another alternative embodiment of the present invention, then the proposed first isolation barrier 211 may further comprise a plurality of more first isolation capacitors which are connected in series and a plurality of more third isolation capacitors which are connected in series. As disclosed in the previous embodiment in FIG. 3, a plurality of serially connected first isolation capacitors C11, C12, C13 . . . . CIN and a plurality of serially connected third isolation capacitors C31, C32 . . . can be configured. As a result, in such a modified embodiment, it should be apparent that even if the hard force (stress, or stiffness) generated by the first metal wire bonding M1 and the second metal wire bonding M2 affects the dielectric layer, the affected area is merely limited to the top dielectric layer IMD1 of the first isolation capacitor C11 and the dielectric layer IMX1 of the 5 third isolation capacitor C31, and will not affect its underlying other dielectric layers IMD2, IMD3 . . . . IMDN of the first isolation capacitors C12, C13 . . . . CIN and the dielectric layer IMX2 of the third isolation capacitor C32.

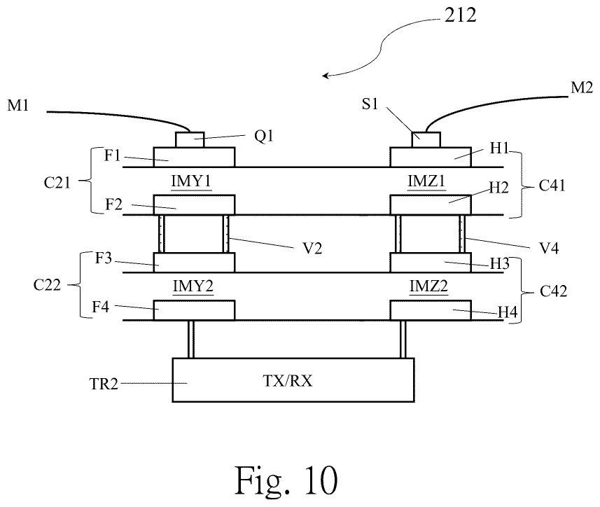

In similar configuration manners, please refer to FIG. 10, in which FIG. 10 shows a structural diagram schematically illustrating a detailed configuration of the above mentioned second isolation barrier 212 according to the second embodiment of the present invention. As can be seen in FIG. 10, the proposed second isolation barrier 212 in the second embodiment comprises serially connected second isolation capacitors C21, C22 constituting the first data transmission channel and serially connected fourth isolation capacitors C41, C42 constituting the second data transmission channel. Specifically, the second isolation capacitor C21 includes an upper metal plate F1, a lower metal plate F2, and a dielectric layer IMY1 disposed between the upper metal plate F1 and the lower metal plate F2. An open pad Q1 is disposed and configured on the upper metal plate F1, thereby providing the first metal wire bonding M1 is connected thereto. The fourth isolation capacitor C41 includes an upper metal plate H1, a lower metal plate H2, and a dielectric layer IMZ1 disposed between the upper metal plate H1 and the lower metal plate H2. An open pad S1 is disposed and configured on the upper metal plate H1, thereby providing the second metal wire bonding M2 is connected thereto.

On the other hand, the second isolation capacitor C22 includes an upper metal plate F3, a lower metal plate F4, and a dielectric layer IMY2 disposed between the upper metal plate F3 and the lower metal plate F4. Furthermore, the fourth isolation capacitor C42 includes an upper metal plate H3, a lower metal plate H4, and a dielectric layer IMZ2 disposed between the upper metal plate H3 and the lower metal plate H4. In the two second isolation capacitors C21, C22 which are connected in series, the lower metal plate F2 of the second isolation capacitor C21 and the upper metal plate F3 of the second isolation capacitor C22 are electrically connected through a second inner metal via V2. And in the two fourth isolation capacitors C41, C42 which are connected in series, the lower metal plate H2 of the fourth isolation capacitor C41 and the upper metal plate H3 of the fourth isolation capacitor C42 are electrically connected through a fourth inner metal via V4.

According to the embodiment of the present invention, the second isolation capacitor C21 and the fourth isolation capacitor C41 which are electrically connected in parallel in the second isolation barrier 212 commonly uses a same metal electrode plate. And the second isolation capacitor C22 and the fourth isolation capacitor C42 which are electrically connected in parallel are also operable to commonly use a same metal electrode plate.

As a result, by adopting such circuit configurations, since the proposed second isolation barrier 212 is composed of multiple serially connected second isolation capacitors C21, C22 and multiple serially connected fourth isolation capacitors C41, C42, having both upper plate and lower plate made of metal material, it is known that the metal material is relatively soft, so it can be effective to reduce the damage to the dielectric layer generated by the hard force due to the first metal wire bonding M1 as well as the second metal wire bonding M2. In other words, even if the hard force (stress, or stiffness) generated by the first metal wire bonding M1 and the second metal wire bonding M2 affects the dielectric layer, the affected area is merely limited to the dielectric layer IMY1 of the second isolation capacitor C21 and the dielectric layer IMZ1 of the fourth isolation capacitor C41 and yet, will not affect its underlying dielectric layers IMY2 and IMZ2.

And moreover, in another aspect, according to one another alternative embodiment of the present invention, then the proposed second isolation barrier 212 may further comprise a plurality of more second isolation capacitors which are connected in series and a plurality of more fourth isolation capacitors which are connected in series. As disclosed in the previous embodiment in FIG. 5, a plurality of serially connected second isolation capacitors C21, C22, C23 . . . . C2N and a plurality of serially connected fourth isolation capacitors C41, C42 . . . can be configured. As a result, in such a modified embodiment, it should be apparent that even if the hard force (stress, or stiffness) generated by the first metal wire bonding M1 and the second metal wire bonding M2 affects the dielectric layer, the affected area is merely limited to the top dielectric layer IMY1 of the second isolation capacitor C21 and the dielectric layer IMZ1 of the fourth isolation capacitor C41, and will not affect its underlying other dielectric layers IMY2, IMY3 . . . . IMYN of the second isolation capacitors C22, C23 . . . . C2N and the dielectric layer IMZ2 of the fourth isolation capacitor C42. In general, the above described plurality of modified embodiments of the present invention are applicable and can be implemented for achieving the inventive objectives and effects of this Application.

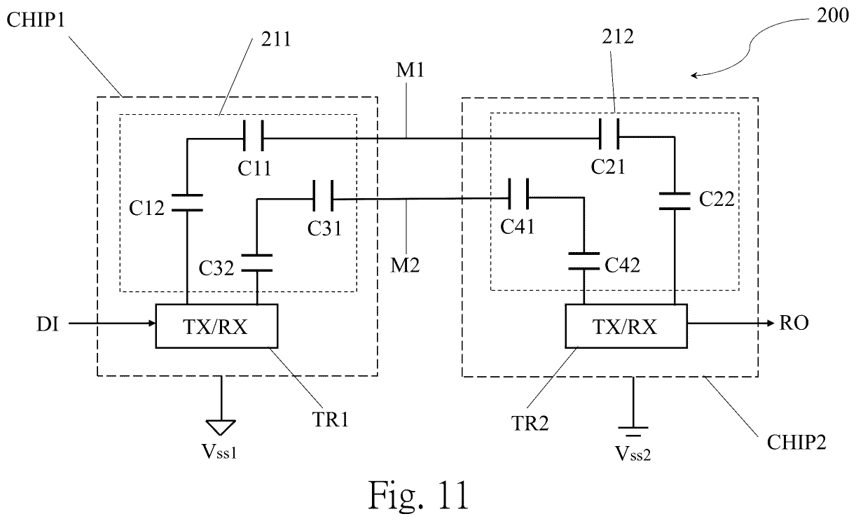

And in addition, according to the disclosed digital isolator circuit with serially connected isolation capacitors in the second embodiment of the present invention, a bi-directional data transmission can also be implemented. For instance, in one applicable embodiment of the present invention, please refer to FIG. 11, wherein when the first transceiver TR1 in the first integrated circuit region CHIP1 is adapted to receive a data input signal DI and in response to the data input signal DI, the first transceiver TR1 is operable to generate an isolated output signal through the first isolation barrier 211. And afterwards, by employing the signal coupling due to the second isolation barrier 212, the second transceiver TR2 in the second integrated circuit region CHIP2 can be adapted to receive the isolated output signal so as to generate a data output signal RO.

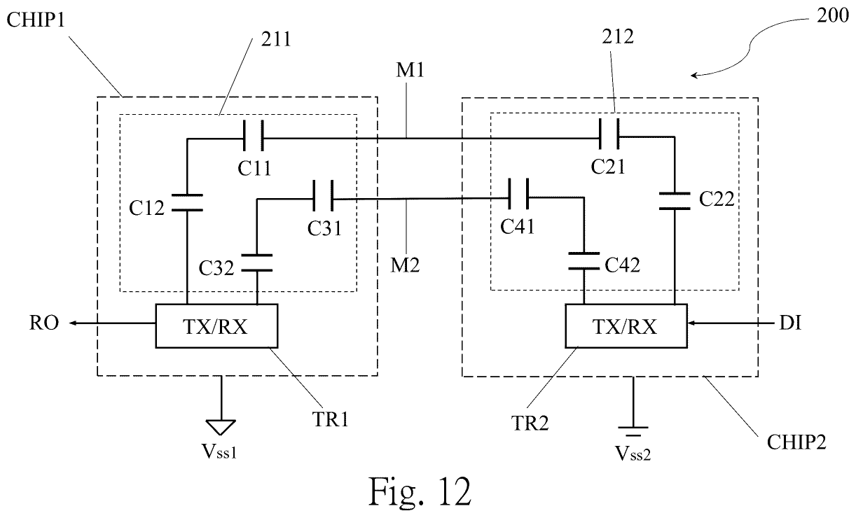

And alternatively, according to another applicable embodiment of the present invention, for example, please refer to FIG. 12. As can be seen in FIG. 12, when the second transceiver TR2 in the second integrated circuit region CHIP2 is adapted to receive a data input signal DI and in response to the data input signal DI, the second transceiver TR2 is operable to generate an isolated output signal through the second isolation barrier 212. And afterwards, by employing the signal coupling due to the first isolation barrier 211, the first transceiver TR1 in the first integrated circuit region CHIP1 can be adapted to receive the isolated output signal so as to generate a data output signal RO. As a result, by employing the bi-directional data transmission design manners as disclosed in FIG. 11 and FIG. 12, the digital isolator circuit as previously disclosed in the embodiments in FIG. 8-10 may also be designed, providing the bi-directional data transmission functions.

Therefore, to sum up, it is believed that the technical solutions disclosed herein the present invention are proposed so as to effectively suppress the impact of the hard force (stress) generated by metal wire bonding in the prior arts, thereby maintaining a well voltage withstanding capability of the digital isolator circuit. Furthermore, since the hard force interference caused by metal wire bonding can be effectively controlled and suppressed by the present invention, when the digital isolator circuit disclosed herein is applied, a much better environmental tolerance for the device's packaging and encapsulation environment can be achieved. In other words, while performing a wire bonding encapsulation process, relatively low-cost metal wires such as copper and silver can be used for metal bonding, replacing the use of expensive metal wires such as gold. Such merits significantly help to reduce the cost of metal bonding for the device and therefore, provide greater market advantages and competitiveness for the disclosed digital isolator circuit of the present invention.

In general, the Applicant of the present invention has provided detailed descriptions in the above-mentioned paragraphs for implementation for the plurality of embodiments of the present invention. Feasibility and the achievable inventive effects of the invention have been verified as well. As such, for those skilled in the technical arts, equivalent modifications and variations based on the present invention without departing from the spirits of the invention are applicable. Nevertheless, it should be acknowledged that such modified embodiments should still fall within the claim scope of the present invention.

Therefore, based on at least one embodiment as provided above, it is believed that the proposed digital isolator circuit of the present invention is novel and inventive, characterized by employing a plurality of serially connected isolation capacitors. By adopting the proposed serially connected isolation capacitors in the digital isolator circuit, in addition to achieving the above-mentioned invention effects, accuracy of data transmission and stability of the circuit output voltage without jitter interferences can be accomplished as well. As a result, it is believed that the output voltage robustness of the circuit is superior at the same time.

As can be seen in view of the above disclosed embodiments, the present invention is aimed to propose and provide a great number of merits and advantages which can be accomplished by adopting the present invention. Therefore, in view of all, it is obvious that the present invention is not only novel and inventive but also believed to be advantageous of solving and avoiding the conventional issues existing in the prior arts. As a result, when compared to the prior arts, it is ensured that the present invention apparently shows much more effective performances than before. In addition, it is believed that the present invention is instinct, effective and highly competitive for IC technology and industries in the market nowadays, whereby having extraordinary availability and competitiveness for future industrial developments and being in condition for early allowance.

It will be apparent to those skilled in the art that various modifications and variations can be made to the present invention without departing from the scope or spirit of the invention. In view of the foregoing, it is intended that the present invention cover modifications and variations of this invention provided they fall within the scope of the invention and its equivalent.

What is claimed is:

1. A digital isolator circuit with serially connected isolation capacitors, comprising:
a first integrated circuit region, comprising a first transceiver and a first isolation barrier, wherein the first isolation barrier includes a plurality of first isolation capacitors, and the plurality of first isolation capacitors are electrically connected in series; and
a second integrated circuit region, comprising a second transceiver and a second isolation barrier, wherein the second isolation barrier includes a plurality of second isolation capacitors, and the plurality of second isolation capacitors are electrically connected in series;
wherein a first metal wire bonding is electrically connected between the plurality of first isolation capacitors and the plurality of second isolation capacitors, and the first metal wire bonding is only configured and disposed between one of the plurality of first isolation capacitors and one of the plurality of second isolation capacitors without contacting with another one of the plurality of first isolation capacitors which is connected with the first transceiver and without contacting with another one of the plurality of second isolation capacitors which is connected with the second transceiver.

2. The digital isolator circuit with serially connected isolation capacitors according to claim 1, wherein the first transceiver in the first integrated circuit region is adapted to receive a data input signal, in response to the data input signal and operable to generate an isolated output signal.

3. The digital isolator circuit with serially connected isolation capacitors according to claim 2, wherein the second transceiver in the second integrated circuit region is adapted to receive the isolated output signal so as to generate a data output signal.

4. The digital isolator circuit with serially connected isolation capacitors according to claim 1, wherein the second transceiver in the second integrated circuit region is adapted to receive a data input signal, in response to the data input signal and operable to generate an isolated output signal.

5. The digital isolator circuit with serially connected isolation capacitors according to claim 4, wherein the first transceiver in the first integrated circuit region is adapted to receive the isolated output signal so as to generate a data output signal.

6. The digital isolator circuit with serially connected isolation capacitors according to claim 1, wherein the first isolation barrier further comprises a plurality of third isolation capacitors, the plurality of third isolation capacitors are electrically connected in series, the plurality of third isolation capacitors and the plurality of first isolation capacitors are electrically connected in parallel and the plurality of third isolation capacitors are electrically connected with the first transceiver, such that the plurality of third isolation capacitors are operable to provide another data transmission channel.

7. The digital isolator circuit with serially connected isolation capacitors according to claim 6, wherein the second isolation barrier further comprises a plurality of fourth isolation capacitors, the plurality of fourth isolation capacitors are electrically connected in series, the plurality of fourth isolation capacitors and the plurality of second isolation capacitors are electrically connected in parallel and the plurality of fourth isolation capacitors are electrically connected with the plurality of third isolation capacitors and the second transceiver, such that the plurality of fourth isolation capacitors are contributed to provide the another data transmission channel.

8. The digital isolator circuit with serially connected isolation capacitors according to claim 7, wherein a second metal wire bonding is electrically connected between the plurality of third isolation capacitors and the plurality of fourth isolation capacitors, and the second metal wire bonding is only configured and disposed between one of the plurality of third isolation capacitors and one of the plurality of fourth isolation capacitors without contacting with another one of the plurality of third isolation capacitors which is connected with the first transceiver and without contacting with another one of the plurality of fourth isolation capacitors which is connected with the second transceiver.

9. The digital isolator circuit with serially connected isolation capacitors according to claim 1, wherein each of the plurality of first isolation capacitors includes an upper metal plate, a lower metal plate, and a dielectric layer disposed between the upper metal plate and the lower metal plate, and wherein in the two of the plurality of first isolation capacitors which are connected in series, the lower metal plate of one of the plurality of first isolation capacitors and the upper metal plate of another one of the plurality of first isolation capacitors are electrically connected through a first inner metal via.

10. The digital isolator circuit with serially connected isolation capacitors according to claim 1, wherein each of the plurality of second isolation capacitors includes an upper metal plate, a lower metal plate, and a dielectric layer disposed between the upper metal plate and the lower metal plate, and wherein in the two of the plurality of second isolation capacitors which are connected in series, the lower metal plate of one of the plurality of second isolation capacitors and the upper metal plate of another one of the plurality of second isolation capacitors are electrically connected through a second inner metal via.

11. The digital isolator circuit with serially connected isolation capacitors according to claim 8, wherein each of the plurality of third isolation capacitors includes an upper metal plate, a lower metal plate, and a dielectric layer disposed between the upper metal plate and the lower metal plate, and wherein in the two of the plurality of third isolation capacitors which are connected in series, the lower metal plate of one of the plurality of third isolation capacitors and the upper metal plate of another one of the plurality of third isolation capacitors are electrically connected through a third inner metal via.

12. The digital isolator circuit with serially connected isolation capacitors according to claim 8, wherein each of the plurality of fourth isolation capacitors includes an upper metal plate, a lower metal plate, and a dielectric layer disposed between the upper metal plate and the lower metal plate, and wherein in the two of the plurality of fourth isolation capacitors which are connected in series, the lower metal plate of one of the plurality of fourth isolation capacitors and the upper metal plate of another one of the plurality of fourth isolation capacitors are electrically connected through a fourth inner metal via.

13. The digital isolator circuit with serially connected isolation capacitors according to claim 8, wherein one of the plurality of first isolation capacitors and one of the plurality of third isolation capacitors which are electrically connected in parallel in the first isolation barrier commonly uses a same metal electrode plate.

14. The digital isolator circuit with serially connected isolation capacitors according to claim 8, wherein one of the plurality of second isolation capacitors and one of the plurality of fourth isolation capacitors which are electrically connected in parallel in the second isolation barrier commonly uses a same metal electrode plate.

15. A digital isolator circuit with serially connected isolation capacitors, comprising:
a first integrated circuit region, comprising a first transceiver and a first isolation barrier; and
a second integrated circuit region, comprising a second transceiver and a second isolation barrier;
wherein the first isolation barrier comprises a plurality of first isolation capacitors and a plurality of third isolation capacitors, the plurality of first isolation capacitors are electrically connected in series, the plurality of third isolation capacitors are electrically connected in series, and the plurality of third isolation capacitors and the plurality of first isolation capacitors are electrically connected in parallel, and wherein the plurality of first isolation capacitors are electrically connected with the first transceiver so as to provide a first data transmission channel, and the plurality of third isolation capacitors are electrically connected with the first transceiver so as to provide a second data transmission channel; and
wherein the second isolation barrier comprises a plurality of second isolation capacitors and a plurality of fourth isolation capacitors, the plurality of second isolation capacitors are electrically connected in series, the plurality of fourth isolation capacitors are electrically connected in series, and the plurality of fourth isolation capacitors and the plurality of second isolation capacitors are electrically connected in parallel, and wherein the plurality of second isolation capacitors are electrically connected with the plurality of first isolation capacitors and the second transceiver so as to provide the first data transmission channel, and the plurality of fourth isolation capacitors are electrically connected with the plurality of third isolation capacitors and the second transceiver so as to provide the second data transmission channel; and
wherein a first metal wire bonding is electrically connected between the plurality of first isolation capacitors and the plurality of second isolation capacitors, a second metal wire bonding is electrically connected between the plurality of third isolation capacitors and the plurality of fourth isolation capacitors, the first metal wire bonding is only configured and disposed between one of the plurality of first isolation capacitors and one of the plurality of second isolation capacitors without contacting with another one of the plurality of first isolation capacitors which is connected with the first transceiver and without contacting with another one of the plurality of second isolation capacitors which is connected with the second transceiver, and the second metal wire bonding is only configured and disposed between one of the plurality of third isolation capacitors and one of the plurality of fourth isolation capacitors without contacting with another one of the plurality of third isolation capacitors which is connected with the first transceiver and without contacting with another one of the plurality of fourth isolation capacitors which is connected with the second transceiver.

16. The digital isolator circuit with serially connected isolation capacitors according to claim 15, wherein one of the plurality of first isolation capacitors and one of the plurality of third isolation capacitors which are electrically connected in parallel in the first isolation barrier commonly uses a same metal electrode plate.

17. The digital isolator circuit with serially connected isolation capacitors according to claim 15, wherein one of the plurality of second isolation capacitors and one of the plurality of fourth isolation capacitors which are electrically connected in parallel in the second isolation barrier commonly uses a same metal electrode plate.

18. The digital isolator circuit with serially connected isolation capacitors according to claim 15, wherein the first transceiver in the first integrated circuit region is adapted to receive a data input signal, in response to the data input signal and operable to generate an isolated output signal, so that the second transceiver in the second integrated circuit region is adapted to receive the isolated output signal so as to generate a data output signal.

19. The digital isolator circuit with serially connected isolation capacitors according to claim 15, wherein the second transceiver in the second integrated circuit region is adapted to receive a data input signal, in response to the data input signal and operable to generate an isolated output signal, so that the first transceiver in the first integrated circuit region is adapted to receive the isolated output signal so as to generate a data output signal.

20. The digital isolator circuit with serially connected isolation capacitors according to claim 15, wherein each of the plurality of first isolation capacitors, each of the plurality of second isolation capacitors, each of the plurality of third isolation capacitors and each of the plurality of fourth isolation capacitors includes an upper metal plate, a lower metal plate, and a dielectric layer disposed between the upper metal plate and the lower metal plate, and wherein in the two of the plurality of first isolation capacitors which are connected in series, the lower metal plate of one of the plurality of first isolation capacitors and the upper metal plate of another one of the plurality of first isolation capacitors are electrically connected through a first inner metal via, and wherein in the two of the plurality of second isolation capacitors which are connected in series, the lower metal plate of one of the plurality of second isolation capacitors and the upper metal plate of another one of the plurality of second isolation capacitors are electrically connected through a second inner metal via, and wherein in the two of the plurality of third isolation capacitors which are connected in series, the lower metal plate of one of the plurality of third isolation capacitors and the upper metal plate of another one of the plurality of third isolation capacitors are electrically connected through a third inner metal via, and wherein in the two of the plurality of fourth isolation capacitors which are connected in series, the lower metal plate of one of the plurality of fourth isolation capacitors and the upper metal plate of another one of the plurality of fourth isolation capacitors are electrically connected through a fourth inner metal via.
